(19) United States
(12) Patent Application Publication
(10) Pub. No.: US 2006/0283036 A1
(43) Pub. Date: Dec. 21, 2006

(54) Structure for endpiece of a tape rule

(76) Inventor: Jason Huang, Taipei (TW)

Correspondence Address: LOWE HAUPTMAN BERNER, LLP, 1700 DIAGONAL ROAD, SUITE 300, ALEXANDRIA, VA, 22314, US

(21) Appl. No.: 11/155,683

(22) Filed: Jun. 20, 2005

(51) Int. Cl. G01B 3/10

(52) U.S. Cl. 33/758

(57) ABSTRACT

An improved structure for an endpiece of tape rule, said endpiece comprises a measuring tape connecting portion and a hook hanging portion formed by same metal, the tape connecting portion is connected to the surface of measuring tape by rivet(s) penetrates through the holes formed on both of the measuring tape and the measuring tape connecting portion, and at least one magnetic object is attached to at least one concaved groove formed on the surface of the front end of said hook hanging portion.

### BACKGROUND OF THE INVENTION

1. Field of the Invention

The present invention relates to an improvement of tape rule, in particular to a tape rule having magnetic object attached to the surface of the front end of the hook hanging portion of the endpiece, and the rear surface of the hook hanging portion is attached with a slip preventing rubber.

2. Description of Prior Art

It is known to public that the tape rule is a motive and convenient measuring tool. As shown in FIG. 1, in general, the measuring tape B of connectional tape rule is reserved in a housing C. At the end portion of the measuring tape, there is an endpiece A. Said endpiece A contains a connecting plate A1 to be attached onto the end of the measuring tape B, and a hook plate A2 perpendicularly extended from the connecting plate A1. By using the hook plate A2 of the endpiece A, the measuring tape would not be completely pulled into the housing C after measuring is performed. Then, in using the tape rule, it is merely necessary for people to pull the endpiece A and then put the endpiece A against the surface of an article.

However, said endpiece A of tape rule has some disadvantages as follows:

In order to make the hook plate of the endpiece be connected to the measuring tape as an entity, and to prevent inconvenience of carrying the tape rule due to the endpiece. The area of hook plate A2 is made as small as possible. However, since the hook plate A2 is used to hook onto an edge portion of an article, after it is fixed, the measuring tape then is pulled out according to the movement of people, such that the length or distance to be measured is obtained. If the area of hook is too small, it is difficult to hook onto an article and easy to slide away from the article to cause instant rewinding of measuring tape. It is harmful to the user.

In order to improve the problems happened in the endpiece of conventional tape rules, an endpiece having a magnet was disclosed. For example, Taiwan patent publication No. 405703 disclosed an endpiece having mounting holes formed onto it for magnetic objects to be mounted, such that to combine magnetic objects with the endpiece of measuring tape. In addition, Taiwan patent publication No. M258275 discloses a structure for inserting a fixing element having a magnet mounted onto its surface into a plugging groove, so as to form a tape rule with an endpiece having magnet.

However, the above mentioned structures are very complicated, this not only increase the weight of endpiece and decrease the smooth motion of rewinding and releasing measuring tape. Furthermore, the magnets are easy to be separated from the endpiece. Then causes inconvenience to people.

### SUMMARY OF THE INVENTION

It is an object of the present invention to provide an improved structure for the endpiece of tape rule to overcome limitations and disadvantages of tape rule as described above.

According to the improved structure of the endpiece of present invention, the front surface of the hook hanging portion of the endpiece is attached with a magnetic material, such that the endpiece of measuring tape can be attached to objects made of metals.

According to the improved structure of the endpiece of present invention, the front surface of the hook having portion of the endpiece is formed with a concaved groove for holding magnetic material, such that the magnetic material would not separated from the endpiece of measuring tape.

According to the improved structure of the endpiece of present invention, the rear surface of the hook hanging portion of the endpiece is also formed with a concaved groove for holding a slightly extruded slip preventing rubber, such that the endpiece will be prevented from detaching to the objects to be measured.

A more complete understanding of these and other features and advantages of the present invention will become apparent from a careful consideration of the following detailed description of center embodiments illustrated in the accompanying drawings.

### BRIEF DESCRIPTIONS OF THE DRAWINGS

FIG. 1 is a perspective view of conventional tape rule.

FIG. 2 is an exploded perspective view showing the construction of the present invention.

FIG. 3 is a cross-sectional view of the present invention.

FIG. 4 is a cross-sectional view of the second embodiment of present invention.

FIG. 5 is a cross-sectional view of the third embodiment of present invention.

### DETAILED OF THE INVENTION

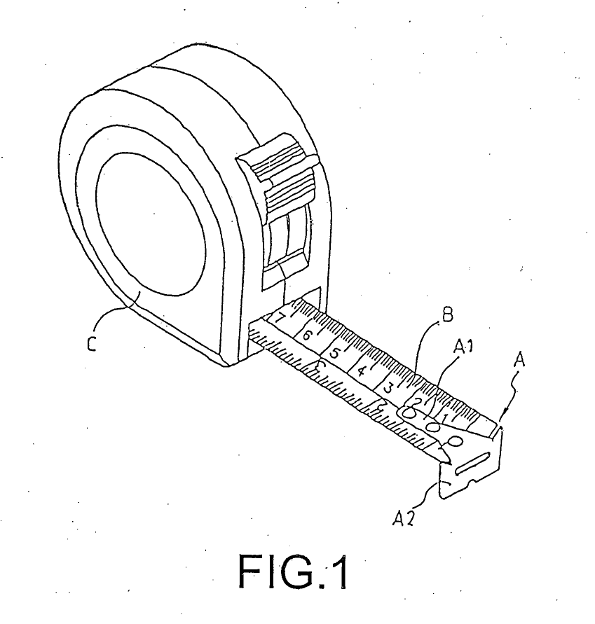

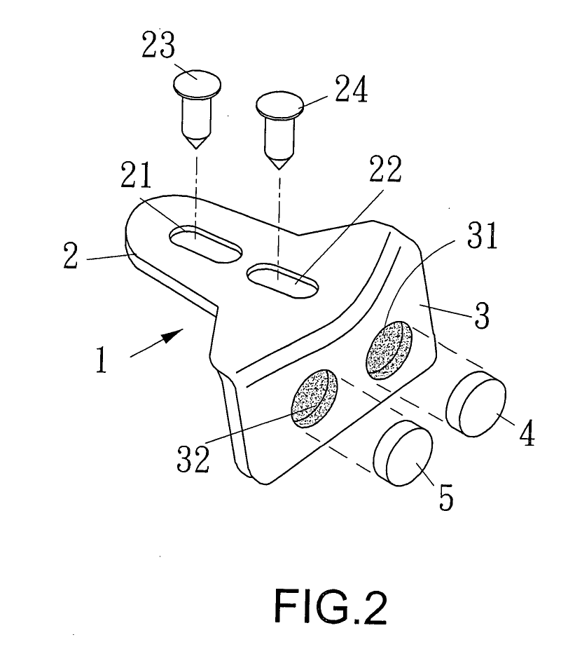

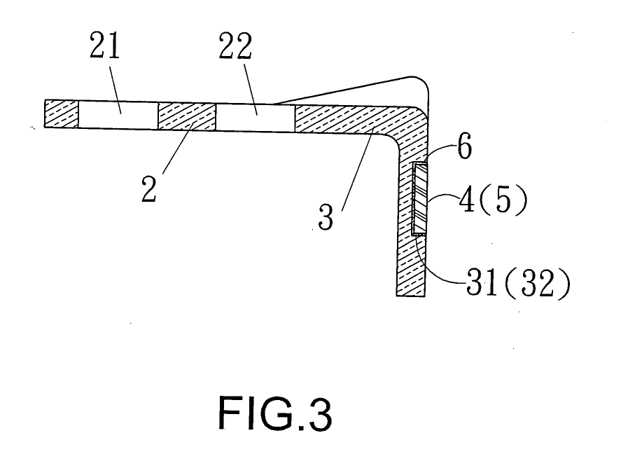

According to the improved structure for the endpiece of the tape rule of the present invention, as shown in FIG. 2 and 3, the endpiece 1 includes a measuring tape connecting portion 2 and a hook hanging portion 3. The measuring tape connecting portion 2 and the hook hanging portion 3 are made by same material to form a whole body. There are two holes 21, 22 for rivets 23, 24 to insert into and connect the endpiece 1 to be firmly attached to the surface of measuring tape (the portion of tape rule denoted by B shown in FIG. 1). There are magnetic objects 4, 5 installed onto the outside of hook hanging portion 3, said magnetic objects are preferably formed as circular plate. On the surface of the hook hanging portion 3, there are concaved grooves 31, 32 corresponding to the magnetic objects 4, 5, such that the magnetic objects 4, 5 can quickly inserted into said concaved grooves 31, 32 to form an entity of endpiece having magnetic objects. In addition, inside the concaved grooves, adhesive agent 6 is filled to increase the adhesive force between magnetic object 4, 5 and the wall of concaved grooves 31, 32.

By the functions of adhesive agent 6 and concaved grooves 31, 32, the magnetic objects 4, 5 can be firmly attached to the hook hanging portion 3. Then it is very convenient to people to use it. And, in manufacturing the present invention, the elements of endpiece can be separately manufactured, and then quickly assembled by operators. The inconveniences of using manufacturing tools can be then prevented.

In using the present invention, people can overcome the inconvenience happened in measuring long distant objects by attaching the magnetic objects 4, 5 to the objects to be measured. Furthermore, when small articles 42 made of iron (for example, screw, nail or nut ect.) are careless to fall into a narrow place, the endpiece 1 of the tape rule can be used to put into the narrow place to attract the small parts for people.

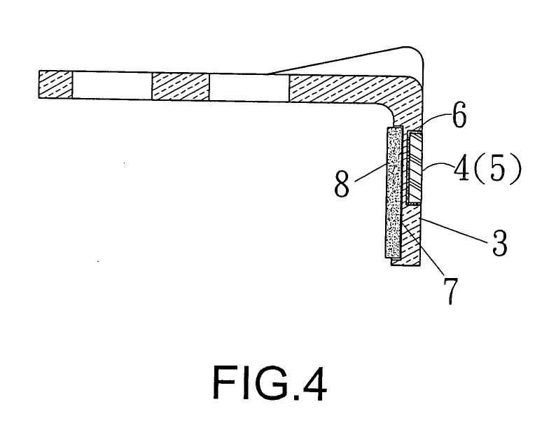

In addition, as shown in FIG. 4, the hook hanging portion 3 not only provides the concaved grooves 6 formed on its front surface for holding magnetic objects 4, 5, the surface of its rear end also can be formed with rear groove 7 for holding elastic slip preventing rubber 8. The slip preventing rubber 8 and rear groove 7 can be combined together by elastic force of slip preventing rubber 8 or by using an adhesive agent. Besides, after the slip preventing rubber 8 is put into the rear groove 7, it can be slightly extruded out of the edge of rear groove 8. Thus when the rear surface of hook hanging portion 3 of the endpiece contacts to an object to be measured, by using the construction futures of extrusion of slip preventing rubber and elasticity of rubber, the rear surface of the hook hanging portion 3 of endpiece 1 can be completely attached to an object. While said attachment is not an attachment between two smooth surfaces, then the attach force between the rear surface of hook hanging portion and object to be measured is increased.

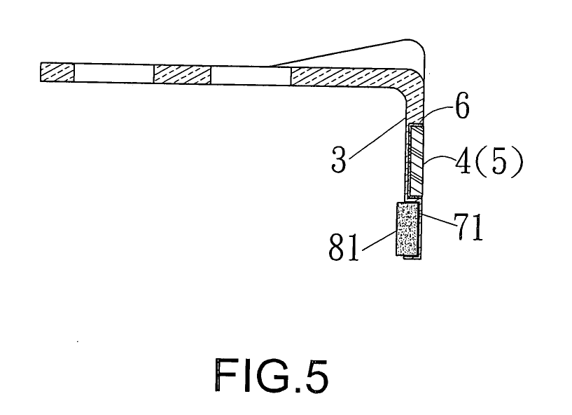

Furthermore, as shown in FIG. 5, when the thickness of hook hanging portion is small and is not capable of providing two grooves on its front and rear surfaces oppose each other, the rear groove 71 can be formed at the lower portion of the hook hanging portion 3. That is, the rear groove 71 is formed at the lower part of said groove 6, and similarly, a slip preventing rubber 81 is put into the rear groove 71.

In this condition, the rear surface of the hook hanging portion 3 of the endpiece can be still completely attached to an object. And this kind of attachment is still not an attachment of two smooth surfaces, then the attach force between the rear surface of hook hanging portion and object to be measured is still increased.

In conclusion from above, according to the improved structure for an endpiece of a tape rule of present invention, the magnetic object is inserted into concaved groove formed on the front surface of the hook hanging portion, then it shall be firmly secured with the hook hanging portion. It is also convenient in assembling of the present invention. The installation of said slip preventing rubber also shall increase the attach force between the rear surface of hook hanging portion and the object to be measured. There is no identical structure for the endpiece of a tape rule has ever seen by people. It is then an invention of novelty.

Although the present invention has been described with a certain degree of particularity, the present disclosure has been made by way of example and changes in details of structure may be made without departing from the spirit thereof.

1. An improved structure for an end piece of a tape rule, said end piece comprising: a measuring tape connecting portion; and a hook hanging portion, both formed of the same metal, the measuring tape connecting portion connected to the surface of a measuring tape by rivet(s) penetrating through holes formed on both of the measuring tape and the measuring tape connecting portion, and at least one magnetic object is attached to at least one concave groove formed on a surface of a front end of said hook hanging portion, wherein, upon attachment of said at least one magnetic object to said at least one concave groove, said front end of said hook hanging portion defines a smooth planar surface.

2. The improved structure for an end piece of a tape rule as claimed in claim 1, wherein between each of said at least one magnetic object and concave groove is filled with an adhesive agent.

3. The improved structure for an end piece of a tape rule as claimed in claim 1, wherein said at least one magnetic object is held in the at least one concave groove formed on the front surface of said hook hanging portion.

4. The improved structure for an end piece of a tape rule as claimed in claim 1, wherein the rear surface of said hook hanging portion is formed with another concave groove, in this groove is inserted a slip preventing rubber.

5. The improved structure for an end piece of a tape rule as claimed in claim 4, wherein said at least one concave groove for holding the slip preventing rubber is opposite to said concave grooves for holding said at least one magnetic object.

6. The improved structure for an end piece of a tape rule as claimed in claim 4, wherein said at least one concave groove for holding the slip preventing rubber is not opposite to said concave grooves for holding said at least one magnetic objects.

7. The improved structure for an end piece of a tape rule as claimed in claim 4, wherein said slip preventing rubber extends outward from the concave groove.

8. An end piece for a measuring tape, said end piece comprising:
a measuring tape connecting portion having a surface defining a plurality of holes, said measuring tape connecting portion being connected to a surface of a measuring tape through rivet(s); and
a hook hanging portion having a front surface and a rear surface, said front surface defining at least one concave groove adapted to receive at least one magnetic object therein, wherein, between each of said at least one magnetic object and concave groove is filled with an adhesive agent and said rear surface of said hook hanging portion defining a groove on a lower portion, said groove adapted to receive a slip preventing rubber, wherein, said slip preventing rubber extends outward from said groove;
wherein, after receiving said at least one magnetic object by said at least one concave groove, said front surface of said hook hanging portion defines a substantially planar surface; and wherein said hook hanging portion and said measuring tape connecting portion are made of the same metal.
